(19) United States
(12) Patent Application Publication
(10) Pub. No.: US 2018/0130120 A1
(43) Pub. Date: May 10, 2018

(54) Inventory Tracking System

(71) Applicant: Koh Herlong, Charlotte, NC (US)

(72) Inventor: Koh Herlong, Charlotte, NC (US)

(21) Appl. No.: 15/347,926

(22) Filed: Nov. 10, 2016

(51) Int. Cl. G06Q 30/06; G06Q 10/08; G06F 17/30

(52) U.S. Cl. CPC G06Q 30/0639; G06F 17/30864; G06Q 10/087

(57) ABSTRACT

An inventory tracking system for locating a specified item in a store includes a store that has an inventory database. An inventory unit is provided and the inventory unit is manipulated by a customer in the store. The inventory unit is in electrical communication with the inventory database to communicate the location of a specified item in the store to the customer thereby facilitating the customer to find the specified item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tracking devices and more particularly pertains to a new tracking device for locating a specified item in a store.

### BRIEF SUMMARY OF THE INVENTION

An embodiment of the disclosure meets the needs presented above by generally comprising a store that has an inventory database. An inventory unit is provided and the inventory unit is manipulated by a customer in the store. The inventory unit is in electrical communication with the inventory database to communicate the location of a specified item in the store to the customer thereby facilitating the customer to find the specified item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an inventory unit of an inventory tracking system according to an embodiment of the disclosure.

FIG. 2 is a back view of an inventory tracking unit of an embodiment of the disclosure.

FIG. 3 is a front view of an inventory tracking unit of an embodiment of the disclosure.

FIG. 4 is a schematic view of an embodiment of the disclosure.

### DETAILED DESCRIPTION OF THE INVENTION

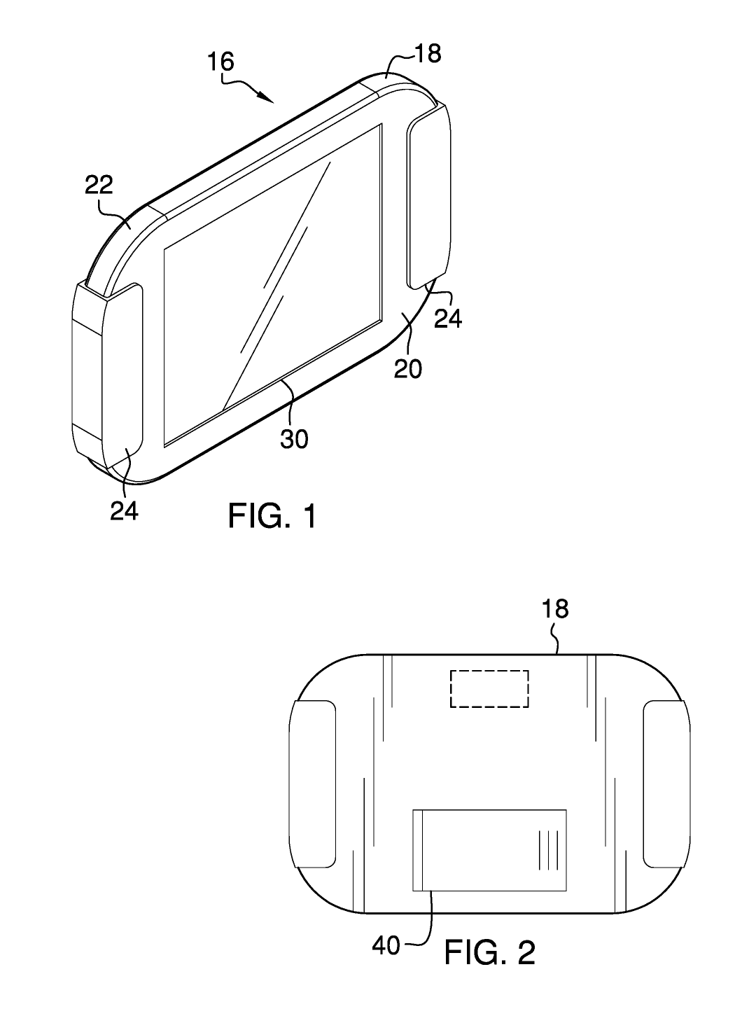

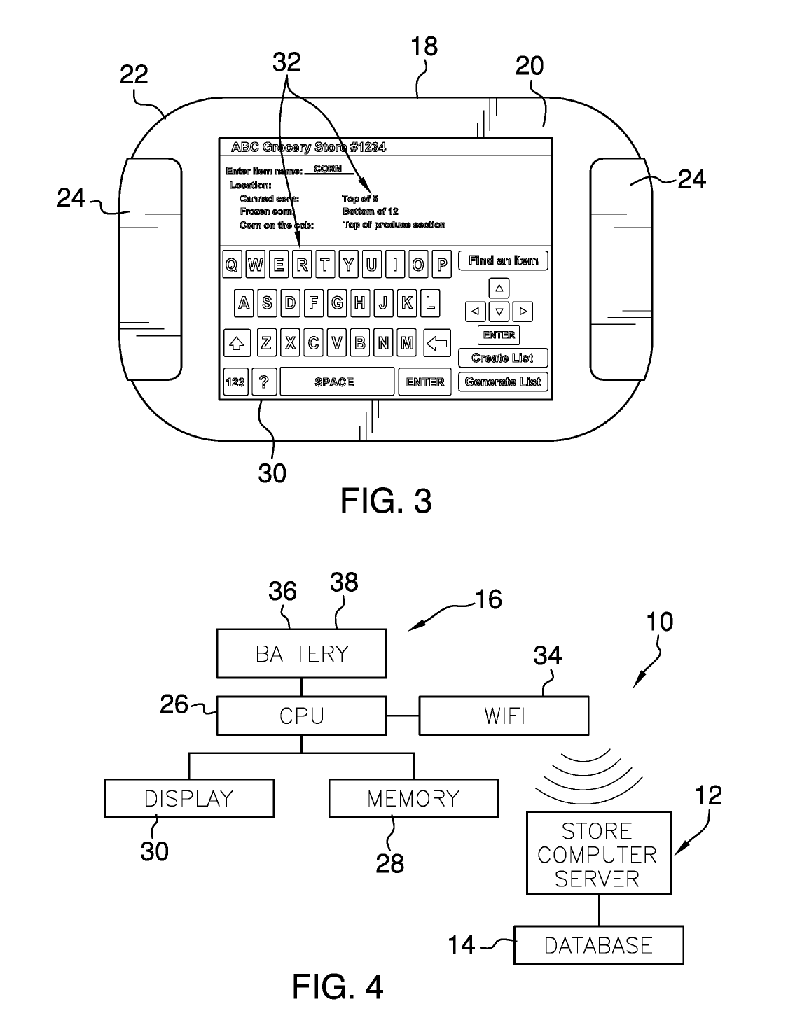

With reference now to the drawings, and in particular to FIGS. 1 through 4 thereof, a new tracking device embodying the principles and concepts of an embodiment of the disclosure and generally designated by the reference numeral 10 will be described.

As best illustrated in FIGS. 1 through 4, the inventory tracking system 10 generally comprises a store 12 that has an inventory database 14. The store 12 may be a clothing store, a grocery store, a hardware store or any retail environment selling in-stock goods. The inventory database 14 may include a computer, a server or other digital means of storing electronic data.

An inventory unit 16 is provided and the inventory unit 16 is manipulated by a customer in the store 12. The inventory unit 16 is in electrical communication with the inventory database 14. In this way, the inventory unit 16 communicates the location of a specified item in the store 12 to the customer thereby facilitating the customer to find the specified item. The inventory unit 16 comprises a housing 18 that may be manipulated and the housing 18 has a front wall 20 and a peripheral edge 22. A pair of grips 24 is provided and each of the grips 24 is coupled to the peripheral edge 22. The grips 24 are positioned on opposite sides of the peripheral edge 22 to enhance gripping the housing 18.

A processor 26 is positioned within the housing 18 and the processor 26 selectively generates a query sequence. The processor 26 may be an electronic processor 26 or the like. An electronic memory 28 is positioned within the housing 18 and the electronic memory 28 is electrically coupled to the processor 26. The electronic memory 28 stores data pertaining to a data entry program.

A touch screen 30 is coupled to the housing 18 and the touch screen 30 is selectively manipulated. The touch screen 30 is positioned on the front wall 20 and the touch screen 30 is electrically coupled to the processor 26. The touch screen 30 touch displays indicia 32 pertaining to the data entry program. The indicia 32 may include icons and text. The icons may define a qwerty keyboard or other GUI (graphic user interface). The indicia 32 on the touch screen 30 are selectively touched to actuate the processor 26 to generate the query sequence corresponding to the specified item. The touch screen 30 may be an LCD touch screen 30 or the like.

A transceiver 34 is positioned within the housing 18 and the transceiver 34 is electrically coupled to the processor 26. The transceiver 34 is in wireless communication with the inventory database 14 such that the transceiver 34 communicates the query sequence to the inventory database 14. The inventory database 14 communicates the location of the specified item to the transceiver 34 and the touch screen 30 displays the location of the specified item. The transceiver 34 may be a radio frequency transceiver 34 or the like and the transceiver 34 may employ a WPAN signal.

A power supply 36 is positioned in the housing 18 and the power supply 36 is electrically coupled to the processor 26. The power supply 36 comprises at least one battery 38. A battery cover 40 is removably coupled the housing 18 and the power supply 36 is positioned beneath the battery cover 40.

In use, the inventory unit 16 is made accessible to the customer when the customer enters the store 12. The customer manipulates the indicia 32 on the touch screen 30 to request a location of the specified item and the processor 26 generates the query sequence. The inventory database 14 communicates the location of the specified item to the processor 26 and the touch screen 30 displays the location of the specified item to the customer. In this way the customer finds the specified item in the store 12. The customer returns the inventory unit 16 to the store 12 when the customer is finished shopping.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An inventory tracking system being configured to selectively display a location of an item in a store, said system comprising:
a store having an inventory database; and
an inventory unit being configured to be manipulated by a customer in said store, said inventory unit being in electrical communication with said inventory database wherein said inventory unit is configured to communicate the location of a specified item in said store to the customer thereby facilitating the customer to find the specified item.

2. The system according to claim 1, wherein said inventory unit comprises:
a housing being configured to be manipulated, said housing having a front wall and a peripheral edge; and
a processor being positioned within said housing, said processor selectively generating a query sequence.

3. The system according to claim 2, further comprising an electronic memory being positioned within said housing, said electronic memory being electrically coupled to said processor, said electronic memory storing data, said data comprising a data entry program.

4. The system according to claim 3, further comprising a touch screen being coupled to said housing wherein said touch screen is configured to be manipulated, said touch screen being positioned on said front wall, said touch screen being electrically coupled to said processor such that said touch screen touch displays indicia, said indicia pertaining to said data entry program wherein said indicia are configured to be selectively touched to actuate said processor to generate said query sequence corresponding to the specified item.

5. The system according to claim 4, further comprising a transceiver being positioned within said housing, said transceiver being electrically coupled to said processor, said transceiver being in wireless communication with said inventory database such that said transceiver communicates said query sequence to said inventory database, said inventory database being configured to communicate the location of the specified item to said transceiver such that said touch screen displays the location of the specified item.

6. The system according to claim 2, further comprising a power supply being positioned in said housing, said power supply being electrically coupled to said processor, said power supply comprising at least one battery.

7. An inventory tracking system being configured to selectively display a location of an item in a store, said system comprising:
a store having an inventory database; and
an inventory unit being configured to be manipulated by a customer in said store, said inventory unit being in electrical communication with said inventory database wherein said inventory unit is configured to communicate the location of a specified item in said store to the customer thereby facilitating the customer to find the specified item, said inventory unit comprising:
a housing being configured to be manipulated, said housing having a front wall and a peripheral edge,
a processor being positioned within said housing, said processor selectively generating a query sequence
an electronic memory being positioned within said housing, said electronic memory being electrically coupled to said processor, said electronic memory storing data, said data comprising a data entry program,
a touch screen being coupled to said housing wherein said touch screen is configured to be manipulated, said touch screen being positioned on said front wall, said touch screen being electrically coupled to said processor such that said touch screen touch displays indicia, said indicia pertaining to said data entry program wherein said indicia are configured to be selectively touched to actuate said processor to generate said query sequence corresponding to the specified item,
a transceiver being positioned within said housing, said transceiver being electrically coupled to said processor, said transceiver being in wireless communication with said inventory database such that said transceiver communicates said query sequence to said inventory database, said inventory database being configured to communicate the location of the specified item to said transceiver such that said touch screen displays the location of the specified item, and
a power supply being positioned in said housing, said power supply being electrically coupled to said processor, said power supply comprising at least one battery.
